(19) United States
(12) Patent Application Publication
(10) Pub. No.: US 2012/0249949 A1
(43) Pub. Date: Oct. 4, 2012

(54) Method for Dyeing Eyeglass Lenses and Colored Lenses

(75) Inventor: Kazuyuki Miyoshi, Sabae-shi (JP)

(73) Assignee: Miyoshi Industrial Enterprise Inc., Sabae-shi (JP)

(21) Appl. No.: 13/495,943

(22) Filed: Jun. 13, 2012

Related U.S. Application Data
(63) Continuation-in-part of application No. PCT/JP2009/070916, filed on Dec. 15, 2009.

(51) Int. Cl. B29D 11/00; G02C 7/02

(52) U.S. Cl. 351/159.66; 264/1.7

(57) ABSTRACT

A method for dyeing eyeglass lenses, which comprise: a step of dyeing at least one surface of a transparent thermoplastic sheet; a step of curving the resulting sheet while heating into a lens-shaped product; and as necessary, a step of providing a power correction layer on the concave side in a unified state. The thermoplastic sheet is a sheet which consists of one material selected from among polycarbonates, acrylic resins, and polyamides and which has a thickness of 1.5 mm or less. Alternatively, the thermoplastic sheet may be a stretched thermoplastic polycarbonate sheet. Further, at least one surface of the thermoplastic sheet may be subjected to hard coating prior to the curving. In this case, the hard-coated surface serves as the convex side of a lens.

### FIELD OF THE INVENTION

This invention relates to a method of dyeing a lenses for glasses and colored glasses by the method.

### BACKGROUND OF THE INVENTION

Some methods for coloring lens for sunglasses are already suggested by third parties. One is the method that a lens is soaked in tank for coloring after forming the lens. The other is the method that a dye is soaked up a lens by heating the lens after we adhere the dye to the surface of lens by sublimation.

We used a method that we applied a dyeability hard coating to the surface of lens in related to the heat-labile material or the material which a dye is hardly soaked up.

For example, there are some prior arts such as “JP4063466B” or “JP2001-279585A”.

The said methods, however, have some problems. The methods cause a rough lens surface because it needs to heat the lens after dyeing and it needs to mix carriers into a stain solution in case of taking deep color. Furthermore, the methods cause the surface curve to transforming by internal force of forming because it needs to heat nearly to deforming temperature of a lens resin, in case that the lens is made of thermoplastic resin. The methods also need high cost when we dye the lens after dyeability hard coat treating.

### BRIEF SUMMARY OF THE INVENTION

Therefore, this invention offers to the method to dyeing lens for glasses easily, considering said problems.

A method for dying eyeglass lenses comprising; a step of dying one side of transparent thermoplastic resin sheet which becomes concave side after bending; a step of bending the dyed sheet for making lens curving as heating it.

Furthermore, in the method for dying eyeglass lenses, the method of dying is to dipping to stain solution.

Furthermore, the method for dying eyeglass lenses comprising, a step of dying one side of transparent thermoplastic resin sheet which becomes concave side after bending; a step of diffusing dye stuff inside concave side of thermoplastic xesin sheet by heating it from concave side in low pressure condition; a step of bending the dyed sheet for making lens curving which dyed side becomes concave side as heating it; a step of attaching a layer for corrected eyesight to the concave side by insert molding.

Dying eyeglass lenses which are made by the method, comprising; a thickness of the thermoplastic sheet is under 1.5 mm; the thermoplastic sheet is one of poly-carbonate, acrylic or polyamide.

The dying eyeglass lenses, comprising; more than one side of the thermoplastic sheet are treated with hard coating; the side with hard coating becomes convex side after bending process.

A method for dying eyeglass lenses comprising; a step of making an absorbing layer by uniformly applying water-soluble acrylic to one side of transparent thermoplastic resin sheet which becomes concave side after bending; a step of transforming dye stuff of the absorbing layer into the thermoplastic resin through firing process after spraying the absorbing layer with dye stuff and making gradation pattern; a step of bending the dyed sheet for making lens curving which dyed side becomes concave side as heating it; a step of attaching a layer for corrected eyesight to the concave side by insert molding.

A method for dying eyeglass lenses which are made of five layers, namely a protective sheet, a thermoplastic sheet, a polarizing sheet (PVA), the other thermoplastic sheet and the other protective sheet in order, comprising; a step of removing a back side protective sheet; a step of dipping the lens sheet into stain solution; a step of dry up the lens sheet in high temperature; a step of removing a surface protective sheet; a step of attaching a thermoplastic lens to the back side of the lens sheet by insert molding.

Furthermore, the method for dying eyeglass lenses, comprising; a step of bending the lens sheet before removing the back side protective sheet.

Dying eyeglass lenses which are made by the method, comprising; the thermoplastic sheet is one of poly-carbonate, TAC or polyamide; the protective sheet is one of soft chloroethylene (PVC) or heat-proof olefin resin.

### EFFECT OF THE INVENTION

It is possible to dye by using gradation printing or two-tone color printing because of dyeing a plane sheet. This invention makes manufacturing process simply because it does not need to choose conditions or tools with lens curve. This invention also gives lenses light exposure properties because dying layer is made on the backside. The dying layer is positioned between thermoplastic sheet and layer for corrected eyesight by positioning the layer for corrected eyesight on the backside of dying layer, therefore, color bleeding does not occur.

By this invention, we can prevent surface dents caused by pressure on process of bend manufacturing because hard coating is made at the phase of sheet making. We can also make hard coating on the condition of plan type, and it increases the way of hard coating and it decreases costs.

### BRIEF DESCRIPTION OF THE DRAWINGS

FIG. 1 (a) shows the process of lens dying according to the Embodiment 1.

FIG. 1 (b) shows the cross sectional view according to the Embodiment 1.

FIG. 2 shows the cross sectional view according to the Embodiment 2.

FIG. 3 (a) shows the process of lens dying according to the Embodiment 3.

FIG. 3 (b) shows the cross sectional view according to the Embodiment 3.

FIG. 4 (a) shows the process of lens dying according to the Embodiment 4.

FIG. 4 (b) shows the cross sectional view according to the Embodiment 4.

FIG. 5 shows the cross sectional view according to the Embodiment 5.

FIG. 6 shows the cross sectional view according to the Embodiment 6.

### BEST MODE FOR CARRYING OUT THE INVENTION

Concrete examples of this invention are described as following.

In this invention, after plane resin sheet is dyed at the phase of dying, then the sheet is formed to lens shape. Because the sheet is plane form, we need not to change an assembly jig corresponding to lens curve, and we need not to change condition of dying. Furthermore, the light exposure properties of lenses is improved because sun light does not hit the dying layer directly by positioning the dying layer on backside of lenses when humans use it. It is better that layer for corrected eyesight is formed on backside after dying and curving because the dying layer is in the lens and color bleeding does not occur.

In this case, it is better that the thickness of the sheet is less than 1.5 mm. If it is over 1.5 mm, it is difficult to curve, and we may need to polish the dying layer when we polish lens to making thick lens after we dye adhesive surface and backside surface in order to form semi-finished lens.

Poly-carbonate, acrylic and polyamide are used for thermoplastic resin. Resins, which are transparent and are colored and are keeping the form, are used for thermoplastic sheet. For example, polyamide (ex. TR-55 by Ems Syowa Denko), poly-carbonate (ex. NOVAREX 7027A by Mitsubishi Engineering Plastic), acrylic and polycarbonate-polyester mixed resin (ref. Patent JP2007-240907) are used for thermoplastic sheet.

If poly-carbonate is used for, it is better to draw the resin because poly-carbonate has high double refraction and internal distortion occurs in the process of curving.

Methods of dying are Optional as long as purpose of this invention will be achieved. For example, dipping to stain solution, dying by inkjet printing and sublimation printing by using sheet printed by inkjet are used for the methods. It becomes possible to use some methods such as silk-screen printing or offset printing, though it is normally impossible for the methods to use to curved surface.

In this invention, it is better to dye resin sheet directly though it is possible to dye hard coating layer. It is possible to cut off the cost of hard coating process because of needless of the process and to prevent unusual density of dying caused of various conditions for making hard in comparison with dying hard coating layer.

A thermoplastic sheet temperature in the bending process of lens is preferably more than deflection temperature under load (0.45 Mpa) arranged by ISO 75-2.

A sufficient heating of bending process makes dyestuff diffusing and dyeing in lens resin, and it declines color bleeding from the surface and improves light exposure properties.

In case that a dying layer or layer for corrected eyesight is on the backside of lens, it also declines color bleeding and improves light exposure properties because the dying layer is far from the lens surface at least thickness of the sheet.

It prevents the lens surface from roughness as the result that the convex as surface lens has already been treated with hard coating in bending process.

It is possible to treat the dying layer with hard coating before dying it, and to dye the hard coating layer. This method may be preferable, in case that layer for corrected eyesight does not been used. To be concrete, it is possible that one side of hard coating layer is dyed after treating both sides with hard coating, and it is also possible that only hard coating layer is dyed or only layer without hard coating is dyed.

In case of using layer for corrected eyesight, one side without layer for corrected eyesight is treated with hard coating because layer for corrected eyesight uneasily adheres to layer with hard coating. In case of using hard sheets such as acrylic sheets, hard coating treatment is optional.

It is possible to dye one side after the process of sheet bending. In this case, it is necessary to attach hydrophobic protective sheets to both sides of lens before bending process. The protective sheets are detached from backside of the lens after bending process, and dipped to stain solution tank. The backside without protective sheet is dyed by stain solution. On the other hand, the surface side with protective sheet is not dyed by stain solution because the stain solution cannot go through the protective sheet.

Moisture in the sheet is removed by drying the sheet with high temperature, and dye stuff is diffused in the sheet uniformly. At the last process, thermoplastic resin lens is attached to the backside of the sheet, and dying lens is completed.

By this method, it is possible to dye only desired one side of sheet uniformly in the process of making lens.

### Embodiment 1

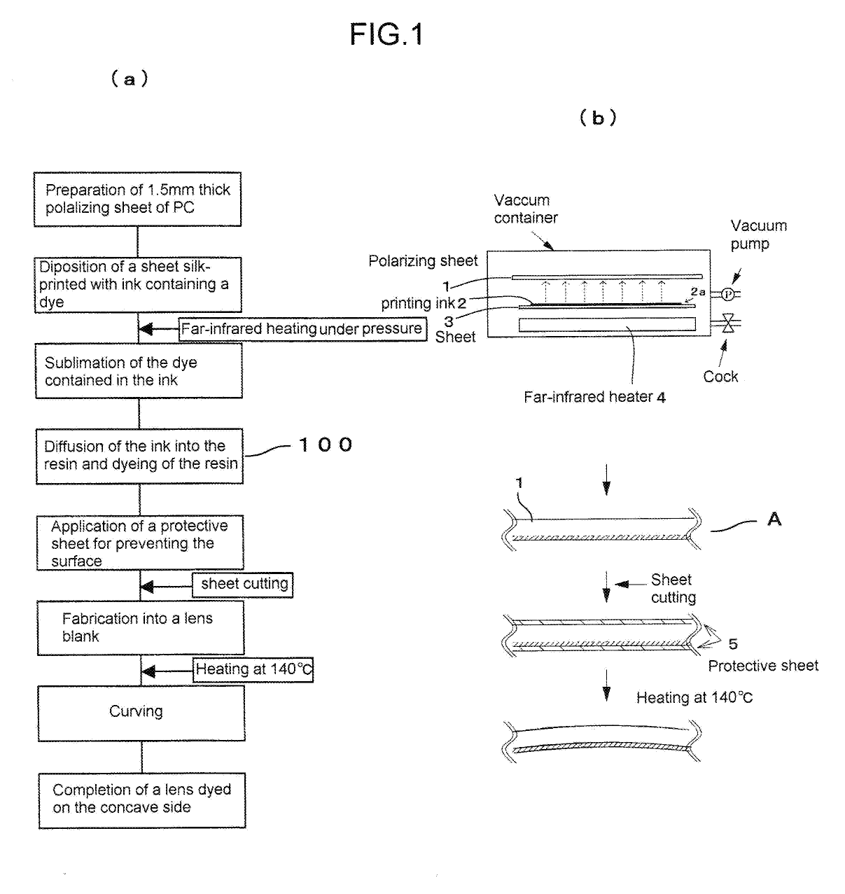

We explains first embodiment of this invention as referring FIG. 1 (a)(b).

A poly-carbonate polarizing sheet (1) which thickness is 1.5 mm and a silk-screen printing sheet (3) by using ink (2) dye stuff is dispersed are prepared. A printed side (2a) of printing sheet is established on poly-carbonate polarizing sheet face to face at regular intervals in decompression container. A printing sheet and poly-carbonate polarizing sheet are heated by infrared heater (4) from backside of poly-carbonate polarizing sheet on the condition of depression (FIG. 1 (a) (b)). The dyestuff is sublimed. The sublimed dye stuff attaches to the surface of poly-carbonate polarizing sheet heated by infrared heater, and after that, it diffuses in the polarizing sheet. The only one side of poly-carbonate polarizing sheet is dyed (FIG. 1 (a) 100, FIG. 1 (b) A).

Protective sheets (5) are attached to the both side of the poly-carbonate polarizing sheet (FIG. 1 (b)). After cutting it in order to form lens, we bend it with heating at 140° C. Lens for sunglasses, which has lens curve and whose concave side is dyed, is completed.

When humans put on the glasses, sunlight hits to the surface side (convex side). This invention improves the light exposure properties because dying layer is on the backside (concave side) and sunlight hits to the dying layer through the sheet.

Furthermore, we can improve the light exposure properties by mixing the sheet with ultraviolet absorber such as benzotriazole or benzophenone.

### Embodiment 2

We explain a variation of the invention according to embodiment 1. This variation is the same as the invention of embodiment 1 except for being treated with hard coating on both sides of a polarizing sheet of embodiment 1.

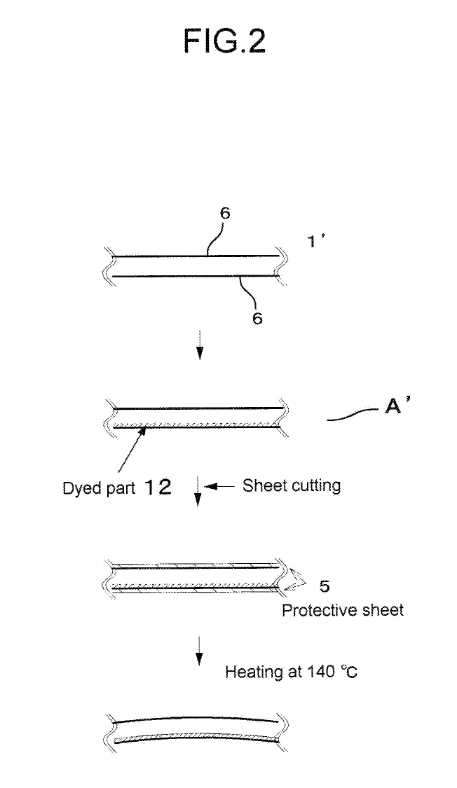

A poly-carbonate polarizing sheet (1′) which thickness is 1.5 mm and of which both sides are treated with acrylic hard coating, and a silk-screen printing sheet (3) by using ink (2) dye stuff is dispersed are prepared. A printed side (2a) of printing sheet is established on poly-carbonate polarizing sheet face to face at regular intervals in decompression container. A printing sheet and poly-carbonate polarizing sheet are heated by far-infrared radiation from backside of poly-carbonate polarizing sheet on, the condition of depression. The dye stuff is sublimed. The sublimed dye stuff attaches to the layer treated by acrylic hard coating, namely, the surface of poly-carbonate polarizing sheet heated by infrared heater, and after that, it diffuses in the polarizing sheet and it forms dyed segment (12). The only one side of poly-carbonate polarizing sheet of which both sides are treated with hard coating is dyed (FIG. 2 (A′)).

Protective sheets are applied to the both sides of dyed poly-carbonate sheet. After cutting it in order to make, lens form, it is bent with 140° C. heating. Curving lens for sunglasses of which concave is dyed are completed.

### Embodiment 3

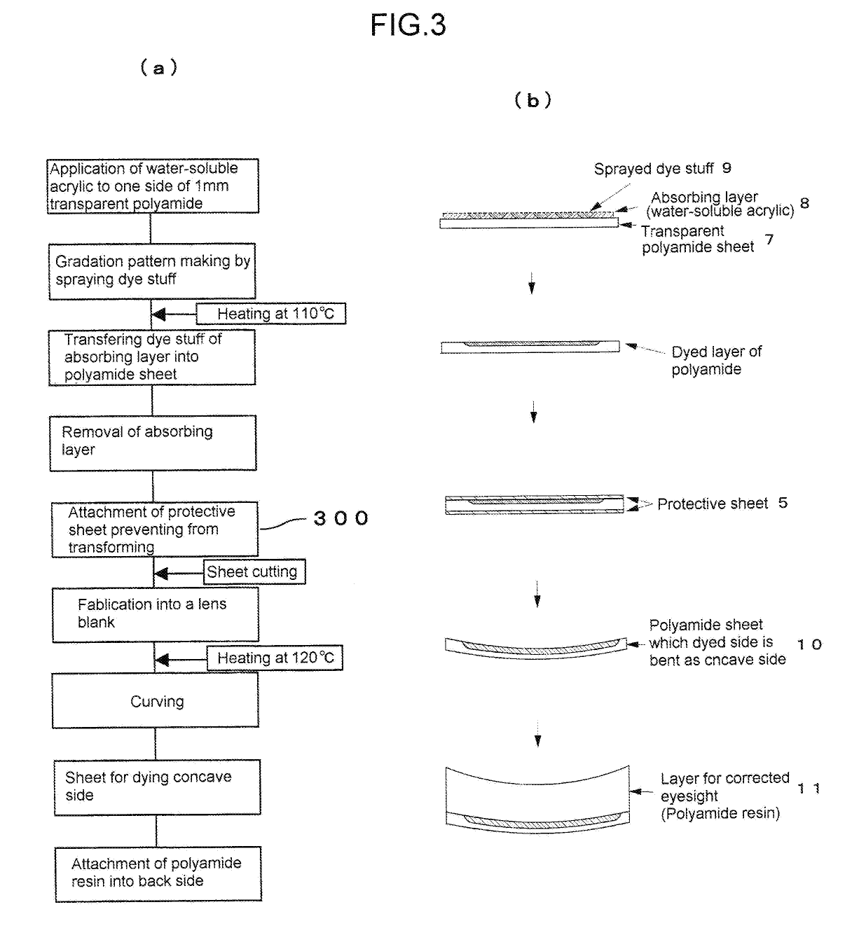

We explain a third embodiment of the invention referring to FIG. 3. An absorbing layer is formed by uniformly applying water-soluble acrylic to one side of 1 mm transparent polyamide sheet (7)(deflection temperature under load: 0.45 Mpa 115° C.). The resulted absorbing layer is sprayed with dye stuff by using ink jet printer in order to print gradation pattern, and then, the dye stuff can be transferred to polyamide sheet by firing them at 110 degrees.

After the absorbing layer is exfoliated, protective sheets (FIG. 3, 300) are attached in order to prevent the surface of sheet from transforming at bending process. After cutting the sheet, the sheet is bended with heating at 120 degrees, and the colored sheet (10) that has concave-dyed lens curving can be obtained.

Polyamide resin (11) as power correction layer is attached to the back face of colored sheet by insert molding, and semi-finished lens can be obtained.

The semi-finished lens has gradation colored layer 1 mm inside of the lens from the surface, and there are no dissolution of the dye stuff when the lens is soaked into alcoholic liquid solution.

As using the above method for dyeing, it can be possible to dye in gradation pattern because bending lens are not directly dyed, and it can be possible to manufacture colored lens that has high coloring effect.

There are no roughness or pitting on the surface of the lenses.

### Embodiment 4

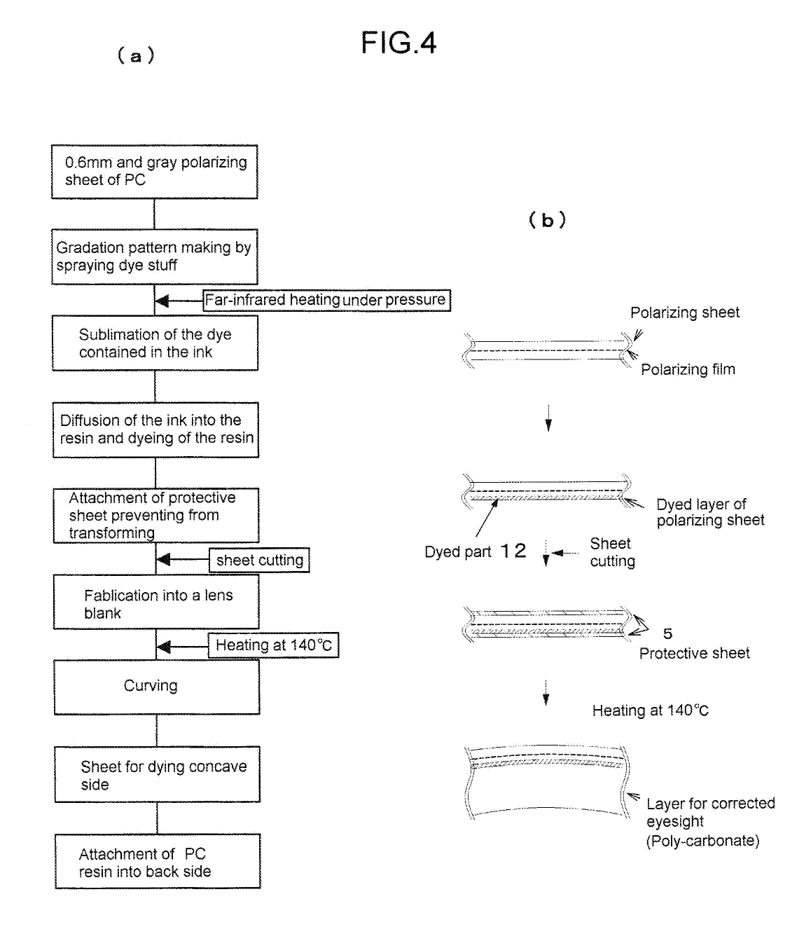

We explain a forth embodiment of the invention referring to FIG. 4. A poly-carbonate polarizing sheet which color is light gray and which thickness is 0.6 mm (deflection temperature under load: 0.45 Mpa 145° C.), and the sheet that a red gradation pattern is printed in absorbing layer by ink jet printer are prepared inside a low pressure container. The printed sheet is set up at regular intervals as the printed side of sheet faces the poly-carbonate polarizing sheet, and the printed sheet and the poly-carbonate polarizing sheet are heated by far-infrared radiation from the opposite side to the poly-carbonate polarizing sheet in pressure situation. The dye stuff can be sublimated. The sublimated dye stuff attaches to the surface of poly-carbonate, which is also heated by far-infrared radiation, and the sublimated dye stuff diffuses inside the poly-carbonate. By using this method, the single side of poly-carbonate polarizing sheet can be dyed (a dyed part (12)).

Protective sheets (5) are attached to the both faces of dyed poly-carbonate sheet, and lens form is made by cutting it, and it is bent at 140 degree heating. The polarizing sheet that has concave-dyed lens curving can be obtained.

The sheet is inserted into the mold and poly-carbonate resin is attached to its concave position. The poly-carbonate polarizing semi-finished lenses are obtained.

The polarizing semi-finished lenses have gradation pattern color that changes from gray to red gray as the result of combination the light gray color of polarizing layer and red gradation.

By using the above method for dyeing of this invention, it can be possible to manufacture polarizing lenses that have complex colors. Furthermore, we are not anxious about transformation at the process of dyeing.

### Embodiment 5

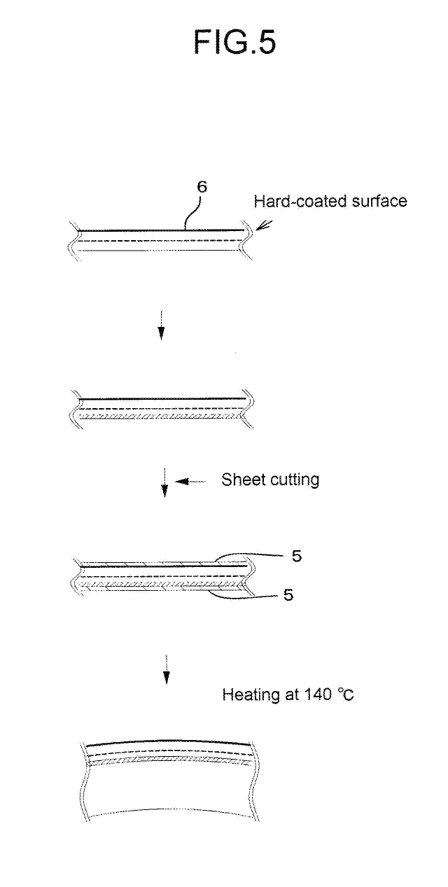

We explain a fifth embodiment of the invention referring to FIG. 5. This embodiment is another example that hard coating process is added in the phase of sheet of the embodiment 4.

A one side acrylic-hard-coated (6) poly-carbonate polarizing sheet which color is light gray and which thickness is 0.6 mm (deflection temperature under load: 0.45 Mpa 145° C.), and the sheet that a red gradation pattern is printed in absorbing layer by ink jet printer are prepared inside a low pressure container. The printed sheet is set up at regular intervals as the printed side of sheet faces the opposite side to hard-coated side of poly-carbonate polarizing sheet, and the printed sheet and the poly-carbonate polarizing sheet are heated by far-infrared radiation from the opposite side to the poly-carbonate polarizing sheet in pressure situation. The dye stuff can be sublimated. The sublimated dye stuff attaches to the surface of poly-carbonate, which is also heated by far-infrared radiation, and the sublimated dye stuff diffuses inside the poly-carbonate. By using this method, the single side of poly-carbonate polarizing sheet can be dyed.

Protective sheets (5) are attached to the both faces of dyed poly-carbonate sheet, and lens form is made by cutting it, and it is bent at 140 degree heating. The polarizing sheet that has hard-coated face on convex. side and that has concave-dyed lens curving can be obtained.

The sheet is inserted into the mold and poly-carbonate resin is attached to its concave position. The poly-carbonate polarizing semi-finished lenses are obtained.

The polarizing semi-finished lenses have gradation pattern color that changes from gray to red gray as the result of combination the light gray color of polarizing layer and red gradation.

As the result that the single side is treated with hard coating, roughness and pitting does not occur in the bending process, and the poly-carbonate resin can be easily attached to the concave face, of sheet because only single face is treated with hard coating.

### Embodiment 6

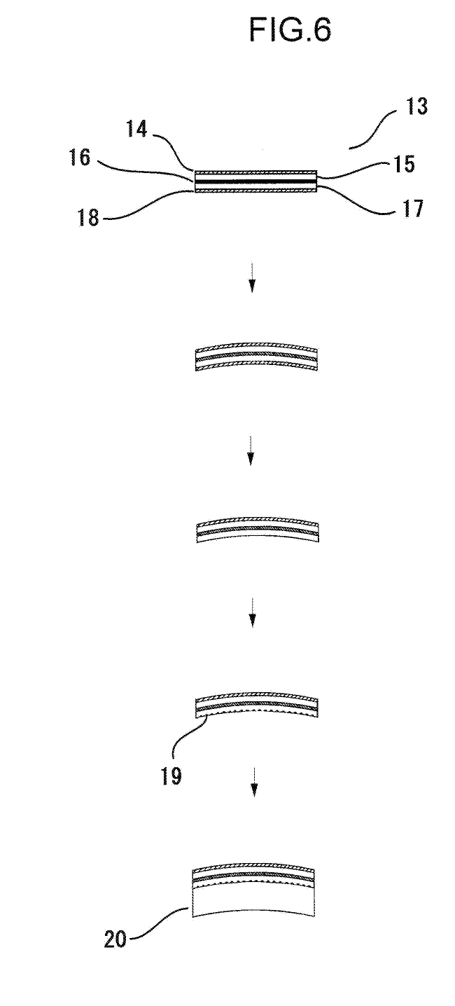

We explain a sixth embodiment of the invention referring to FIG. 6. Through the first embodiment and fifth embodiment, we explain the method and lens by the method that bending process of lens is made after the dyeing process. In this embodiment, we explain the method and lens by the method that dyeing process of lens is made after the bending process.

In this method, lens sheet (13) that is made of 5 layers is manufactured. As the top figure of FIG. 6 shows, the 5 layers mean a protective sheet (14), a thermoplastic sheet (15), a polarizing sheet (16), the other thermoplastic sheet (17) and the other protective sheet (18) in order.

The protective sheet is made of soft chloroethylene (PVC) or heat-proof olefin resin. The thermoplastic sheet is made of poly-carbonate, TAC or polyamide. It is desirable that the poly-carbonate or polyamide thermoplastic sheet is used as back face of lens and the poly-carbonate, TAC or polyamide thermoplastic sheet is used as surface of lens.

Firstly, the said lens sheet is punched in order to insert to a mold.

Secondly, the said lens sheet is bent by pushing it to curving plate. The temperature of bending process is the same or more as glass transition point (Tg point). The said glass transition point is different by thermoplastic sheet. For example, poly-carbonate sheet is about 150 degree and polyamide is 120 degree-140 degree.

It can be possible to bend the lens sheet in a smooth curve because the protective sheets are attached to the surface and back face of lens sheet.

After bending process, the protective sheet (18) of back face (or concave side) is detached.

And the lens sheet is dipped into a stain solution tank. The tank is filled with stain solution. The protective sheet (14) of surface does not let dye stuff easily because the protective sheet is made of hydrophobic resin such as PVC (soft chloroethylene) or heat-proof olefin resin. So, the surface of lens sheet does not be dyed.

On the other hand, the back face of lens sheet, namely back face of thermoplastic resin, is dyed because the protective sheet of back side is detached and the thermoplastic resin such as poly-carbonate or polyamide comes in contact with the dye stuff directly.

Though the right side and left side of the lens sheet are also dyed, there is no problem because the right side and left side are planed. Inhibitory arrangement about dyeing is unnecessary.

The lens sheet is dried because the thermoplastic sheet and polarizing sheet absorb water through dyeing process. By heating the lens sheet, the dye stuff (19) of thermoplastic resin of back side diffuses, and the sheet can be dyed uniformly.

Finally, the protective sheet of surface is detached, and a thermoplastic resin (20) such as poly-carbonate can be attached to the lens sheet by using a mold. As the result, the colored lens of this embodiment can be obtained.

A concrete example about the above method of dyeing lens is explained as following.

As first example, the dyeing method that poly-carbonate as thermoplastic resin is used is explained. A polarizing sheet is put between the thermoplastic resins. The color of the polarizing sheet is gray, and the transmission factor of it is 35%.

The lens sheet is bent by using the curving plate that temperature is 150 degree, and the lens sheet forms 6R curve. The protective sheet of back face (heat-proof olefin resin) is detached.

The stain solution, which combines ion-exchanged water with disperse dye (“daiyanic thread AC-E”) at the rate of 4 g per liter, is prepared. The stain solution is heated at 90 degree, and the lens sheet is dipped into the stain solution with stirring for 40 minutes in order to dye the lens sheet.

The dye stuff stuck to the surface of lens sheet is washed out, the lens sheet is heated at 100 degree for 5 hours and the dye stuff diffused. After that, the protective sheet of surface is detached, and the lens sheet is inserted into a mold. And a polycarbonate resin (“AD-5503 made of Teijin Kasei”) is attached into the back face of the lens sheet.

As the result of the present method, the polarizing sheet, which color is gray like red and which transmission factor is 30%, can be obtained.

As second example, the dyeing method that polyamide as thermoplastic resin is used is explained. A polarizing sheet is put between the thermoplastic resins. The color of the polarizing sheet is gray, and the transmission factor of it is 40%.

The lens sheet is bent by using the curving plate that temperature is 90 degree, and the lens sheet forms 4R curve. The protective sheet of back face (PVC, soft chloroethylene) is detached.

The stain solution, which combines ion-exchanged water with acid dye (“Kayacyl BRUE HRC”) at the rate of 2 g per liter and which is arranged at pH 3 with acetic acid, is prepared. The stain solution is heated at 95 degree, and the lens sheet is dipped into the stain solution with stirring for 10 minutes in order to dye the lens sheet.

The dye stuff stuck to the surface of lens sheet is washed out, the lens sheet is heated at 80 degree for 5 hours and the dye stuff diffused. After that, the protective sheet of surface is detached, and the lens sheet is inserted into a mold. And a polyamide resin (“TR-90 made of EMS Company”) is attached into the back face of the lens sheet.

As the result of the present method, the polarizing sheet, which color is gray like blue and which transmission factor is 35%, can be obtained.

According to the method of the Embodiment 6, the lens sheet is dyed after they are bent. The surface protective sheet can be reused as masking sheet for preventing from dying by leaving only surface protective sheet and by removing back face protective sheet in bending process.

The lens sheet can be molded after drying up it and removing the surface protective sheet. The surface protective sheet can be used in both of bending process and dying process, and we can omit and simplify some production process and we can lower costs.

If we make slow curving lenses, the bending process can be removed. In this case, we remove the back face protective sheet, and we carry out the process of dying and bending, and we can do insert molding after removing the surface protective sheet.

What is claimed is:

1. A method for dying eyeglass lenses comprising;
a step of dying one side of transparent thermoplastic resin sheet which becomes concave side after bending;
a step of bending the dyed sheet for making lens curving as heating it.

2. A method for dying eyeglass lenses according to 1, wherein the method of dying is to dipping to stain solution.

3. A method for dying eyeglass lenses according to 1, wherein;
a step of dying one side of transparent thermoplastic resin sheet which becomes concave side after bending;
a step of diffusing dye stuff inside concave side of thermoplastic resin sheet by heating it from concave side in low pressure condition;
a step of bending the dyed sheet for making lens curving which dyed side becomes concave side as heating it;
a step of attaching a layer for corrected eyesight to the concave side by insert molding.

4. A method for dying eyeglass lenses according to 2, wherein;
a step of dying one side of transparent thermoplastic resin sheet which becomes concave side after bending;
a step of diffusing dye stuff inside concave side of thermoplastic resin sheet by heating it from concave side in low pressure condition;
a step of bending the dyed sheet for making lens curving which dyed side becomes concave side as heating it;
a step of attaching a layer for corrected eyesight to the concave side by insert molding.

5. A method for dying eyeglass lenses comprising;
a step of making an absorbing layer by uniformly applying water-soluble acrylic to one side of transparent thermoplastic resin sheet which becomes concave side after bending;
a step of transforming dye stuff of the absorbing layer into the thermoplastic resin through firing process after spraying the absorbing layer with dye stuff and making gradation pattern;
a step of bending the dyed sheet for making lens curving which dyed side becomes concave side as heating it;
a step of attaching a layer for corrected eyesight to the concave side by insert molding.

6. A method for dying eyeglass lenses which are made of five layers, namely a protective sheet, a thermoplastic sheet, a polarizing sheet (PVA), the other thermoplastic sheet and the other protective sheet in order, comprising;
a step of removing a back side protective sheet;
a step of dipping the lens sheet into stain solution;
a step of dry up the lens sheet in high temperature;
a step of removing a surface protective sheet;
a step of attaching a thermoplastic lens to the back side of the lens sheet by insert molding.

7. A method for dying eyeglass lenses according to 6, wherein;
a step of bending the lens sheet before removing the back side protective sheet.

8. Dying eyeglass lenses which are made by the method according to claim 1, wherein;
a thickness of the thermoplastic sheet is under 1.5 mm;
the thermoplastic sheet is one of poly-carbonate, acrylic or polyamide.

9. Dying eyeglass lenses according to claim 8, wherein more than one side of the thermoplastic sheet are treated with hard coating;
the side with hard coating becomes convex side after bending process.

10. Dying eyeglass lenses which are made by the method according to claim 1, wherein;
the thermoplastic sheet is one of poly-carbonate, TAC or polyamide;
the protective sheet is one of soft chloroethylene (PVC) or heat-proof olefin resin.
